(19) United States
(12) Patent Application Publication
(10) Pub. No.: US 2011/0082691 A1
(43) Pub. Date: Apr. 7, 2011

(54) BROADCASTING SYSTEM INTERWORKING WITH ELECTRONIC DEVICES

(75) Inventors: Seokkap KO, Gwangju (KR); Byung-Tak Lee, Suwon-si (KR); Sim-Kwon Yoon, Gwangju (KR); Nac Woo Kim, Gwangju (KR); Seung-Hun Oh, Gwangju (KR); Jai Sang Koh, Gwangju (KR)

(73) Assignee: Electronics and Telecommunications Research Institute, Daejeon (KR)

(21) Appl. No.: 12/898,098

(22) Filed: Oct. 5, 2010

(30) Foreign Application Priority Data
Oct. 5, 2009 (KR) 10-2009-0094290
Jun. 25, 2010 (KR) 10-2010-0060557

(51) Int. Cl. G10L 19/14

(52) U.S. Cl. 704/205; 704/E19.008

(57) ABSTRACT

Provided is a technology of controlling an electronic device using a broadcasting system. A control signal may be modulated to an audible frequency band and thereby be transmitted from a transmission apparatus to a reception apparatus using the broadcasting system. The reception apparatus may reproduce the control signal of the audible frequency band. A controller may perform a control operation based on the control signal.

### CROSS-REFERENCE TO RELATED APPLICATIONS

This application claims the benefit of Korean Patent Application No. 10-2009-0094290, filed on Oct. 5, 2009, and Korean Patent Application No. 10-2010-0060557, filed on Jun. 25, 2010, in the Korean Intellectual Property Office, the disclosures of which are incorporated herein by reference.

### BACKGROUND

1. Field of the Invention

The present invention relates to a technology of controlling an electronic device, and more particularly, to a technology for mixing a control signal for controlling an electronic device with a voice signal contained in a broadcasting signal.

2. Description of the Related Art

In a conventional broadcasting system, a transmission apparatus may generally transmit an image or voice to a reception apparatus. The reception apparatus may receive the image or the voice and reproduce the image or the voice so that a user may enjoy the image or the voice.

Specifically, the conventional broadcasting system may simply transmit the image or the voice from the transmission apparatus to the reception apparatus. However, the conventional broadcasting system may not include a control channel for controlling a peripheral electronic device of the reception apparatus. Accordingly, to control the peripheral electronic device of the reception apparatus, a broadcasting system may need to be enhanced by newly defining the control channel, or by including a separate control device, and the like.

### SUMMARY

An aspect of the present invention is to control an electronic device using a broadcasting system.

Another aspect of the present invention is to enable a broadcasting system to interwork with an electronic device by minimizing a change in a broadcasting system.

According to an aspect of the present invention, there is provided a transmission apparatus, including: a modulator to modulate a control signal to a frequency band within an audible frequency band; a mixing unit to generate a voice mixed signal by mixing the modulate control signal with a voice signal; and a transmitter to transmit the voice mixed signal to a reception apparatus. The reception apparatus may reproduce the voice mixed signal, and the control signal may be extracted from the reproduced voice mixed signal and is used to control an electronic device.

According to another aspect of the present invention, there is provided an electronic device, including: a microphone to receive a voice mixed signal reproduced by a reception apparatus; a filtering unit to extract, in the voice mixed signal, a control signal modulated to an audible frequency band; a demodulator to demodulate the control signal; and a controller to perform a control operation based on the demodulated control signal. The voice mixed signal may be transmitted from a transmission apparatus to the reception apparatus.

According to still another aspect of the present invention, there is provided an electronic device, including: a microphone to receive a control signal of an audible frequency band mixed with a voice signal; a control signal extractor to extract the control signal in a voice mixed signal; and a controller. The control signal may include a device identifier, a control command, and control data. When the device identifier matches an identifier of the electronic device, the controller may perform a control operation according to the control command by referring to the control data.

According to embodiments of the present invention, it is possible to control an electronic device using a broadcasting system.

Also, according to embodiments of the present invention, it is possible to enable a broadcasting system to interwork with an electronic device by minimizing a change in a broadcasting system.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a waveform of a voice mixed signal according to an embodiment of the present invention;

FIG. 2 illustrates a spectrum of a voice mixed signal according to an embodiment of the present invention;

FIG. 3 is a block diagram illustrating a structure of a transmission apparatus according to an embodiment of the present invention;

FIG. 4 is a block diagram illustrating a structure of an electronic device according to an embodiment of the present invention; and

FIG. 5 is a block diagram illustrating a structure of an electronic device according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

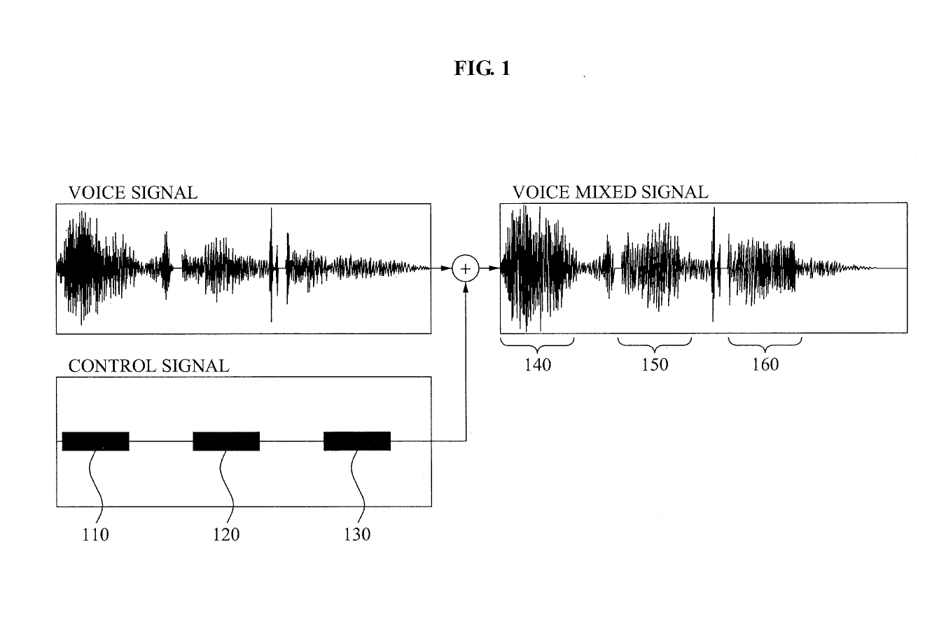

FIG. 1 illustrates a waveform of a voice mixed signal according to an embodiment of the present invention.

A transmission apparatus according to an embodiment of the present invention may generate a voice mixed signal by mixing a voice signal transmitted from a conventional broadcasting system with a control signal for controlling an electronic device.

A broadcasting system of a broadcasting station may be used as the transmission apparatus of the present invention, and a television (TV), a radio, and the like installed at home may be used as a reception apparatus of the present invention.

A voice signal corresponds to an analog signal and thus, may be a signal of an audible frequency band that may be audible to a human being. For example, an audio signal of a TV, a radio signal, and the like for transferring a line of a soap opera, music, a pop song, and the like may be used as the voice signal of the present invention. The voice signal shows a complex waveform according to a pitch of a volume. Specifically, the voice signal may be irregular, and shows a large waveform at a particular moment and shows a small waveform at another moment.

A control signal corresponds to a digital signal and may be expressed as “0” and “1”. The control signal may be modulated to an audible frequency band and thereby be mixed with the voice signal.

A voice mixed signal may be generated by mixing the voice signal with the control signal. As shown in FIG. 1, the voice mixed signal may be generated by adding up two signals.

The voice mixed signal shows a similar waveform to a waveform of the voice signal. However, due to the mixture with the control signal, portions 140, 150, and 160 of the voice mixed signal corresponding to portions 110, 120, and 130 of the control signal may have an enhanced amplitude.

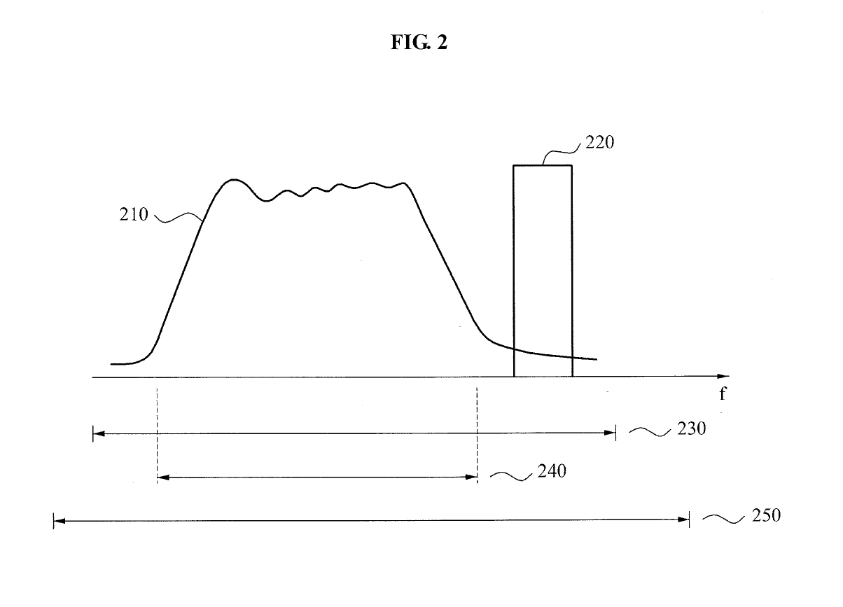

FIG. 2 illustrates a spectrum of a voice mixed signal according to an embodiment of the present invention.

Referring to FIG. 2, a spectrum 210 of a voice signal and a spectrum 220 of a control signals are positioned within an audible frequency band 250. A reception apparatus may reproduce only a signal of a particular frequency band 230 within the audible frequency band 250. However, the spectrums 210 and 220 are positioned within a range where the reception apparatus may reproduce. A speaker of the reception apparatus may reproduce a sound within the particular frequency band 230. Accordingly, the control signal may be reproduced using the speaker of the reception apparatus. When a user perceives the control signal, the user may perceive the control signal as noise.

Even within an audible frequency band of human beings, human beings may clearly perceive a sound within a particular range of a frequency band and may not clearly perceive a sound in other frequency bands. In the present specification, the particular range of frequency band may be referred to as a frequency band of interest 240. The spectrum 220 of the control signal is positioned within the audible frequency band 250, however, is excluded from the frequency band of interest 240. Accordingly, typical human beings without sensitivity to faint sounds may rarely perceive the control signal. Children and the like having sensitivity to faint sounds may minutely perceive the control signal.

According to an embodiment of the present invention, a transmission apparatus may transmit a control signal using a masking scheme. The masking scheme may use an auditory sensory characteristic of human beings and thus, is widely used for a voice compression scheme and the like. By using the masking scheme, when a magnitude of a voice signal is greater than or equal to a predetermined level, the transmission apparatus may insert a control signal into the voice signal. Since a user may concentrate on the voice signal, the user may not perceive the control signal.

According to another embodiment of the present invention, the magnitude of the voice signal may be greater than or equal to the predetermined level for at least a predetermined amount of time. Even in this case, when the control signal is not transmitted, an electronic device may not continuously receive the control signal for the at least a predetermined amount of time. Accordingly, when the magnitude of the voice signal is greater than or equal to the predetermined level for the at least a predetermined amount of time, the transmission apparatus may not transmit the control signal regardless of the magnitude of the voice signal.

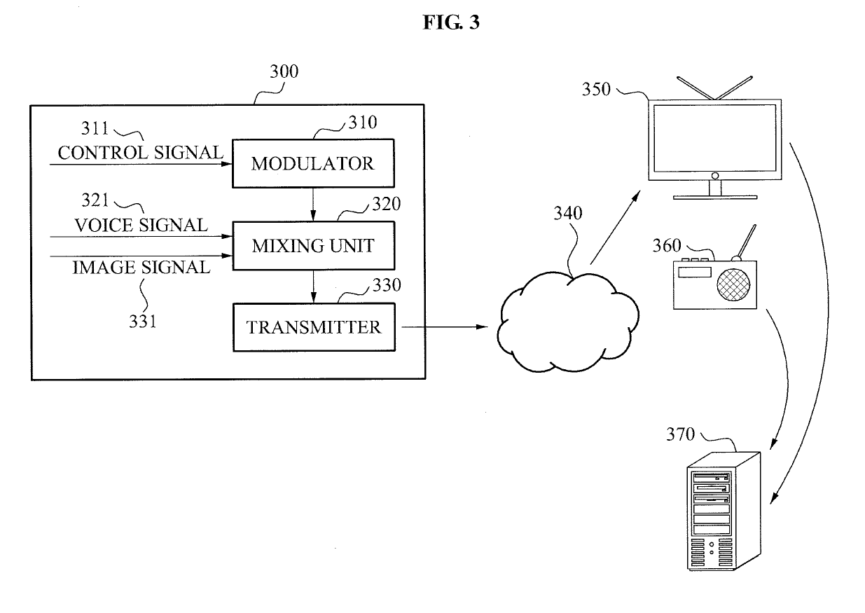

FIG. 3 is a block diagram illustrating a structure of a transmission apparatus 300 according to an embodiment of the present invention.

Referring to FIG. 3, the transmission apparatus 300 may include a modulator 310, a mixing unit 320, and a transmitter 330.

The modulator 310 may modulate a control signal 311 to a frequency band within an audible frequency band. The modulator 310 may modulate the control signal 311 using at least one modulation scheme among a frequency shift keying (FSK) scheme, an amplitude shift keying (ASK) scheme, a quadrature amplitude modulation (QAM) scheme, a phase shift keying (PSK) scheme, a continuous phase modulation (CPM) scheme, a trellis coded modulation (TCM) scheme, an orthogonal frequency division multiplexing (OFDM) scheme, and a spread spectrum scheme. For example, when the modulator 310 modulates the control signal 311 using the FSK scheme, and when the control signal 311 has a value of “0”, the modulator 310 may modulate the control signal 311 to a first frequency. When the control signal 311 has a value of “1”, the modulator 310 may modulate the control signal 311 to a second frequency.

The mixing unit 320 may generate a voice mixed signal by mixing the modulate control signal 311 with a voice signal 321. The mixing unit 320 may mix the modulated control signal 311 with the voice signal 321 using a masking scheme. The masking scheme corresponds to a mixing scheme using a sensory characteristic of human beings and thus, may insert the control signal 311 into a frequency band where human beings may rarely perceive a sound, or may insert the control signal 311 into a section where a volume of the voice signal 321 is relatively great.

When a magnitude of the voice signal 321 is greater than or equal to a predetermined level, the mixing unit 320 may mix the modulated control signal 311 with the voice signal 321.

The magnitude of the voice signal 321 may be continuously greater than or equal to the predetermined level for at least a predetermined amount of time. Even in this case, when the control signal 311 is not transmitted, an electronic device 370 may not continuously receive the control signal 311 for at least a predetermined amount of time. When the magnitude of the voice signal 321 is continuously greater than or equal to the predetermined level for the at least a predetermined amount of time, the mixing unit 320 may mix the control signal 311 with the voice signal 321 regardless of the magnitude of the voice signal 321.

Also, the mixing unit 320 may insert the control signal 311 into a frequency band where human beings may not easily perceive a sound, within an audible frequency band of human being. In this case, the control signal 311 may be positioned in a frequency band higher than the voice signal 321.

The transmitter 330 may transmit the voice mixed signal to a reception apparatus, for example, a TV 350, a radio 360, and the like, over a network 340. The reception apparatus may reproduce the voice mixed signal. The user may perceive the voice signal 321 contained in the voice mixed signal. Some susceptive users may perceive, as noise, the control signal 311 contained in the voice mixed signal.

The electronic device 370 may receive the voice mixed signal reproduced by the reception apparatus, for example, the TV 350, the radio 360, and the like. The electronic device 370 may receive the reproduced voice mixed signal using a microphone.

The electronic device 370 may extract the control signal 311 in the voice mixed signal, and may perform a predetermined control operation based on the control signal 311.

The transmitter 330 may select one channel from a plurality of channels, and transmit the voice mixed signal to the reception apparatus using the selected channel. In this case, the control signal 311 may be determined based on a channel via which the voice mixed signal is to be transmitted. The electronic device 370 may identify the channel via which the voice mixed signal is to be transmitted, using the control signal 311. In this case, the electronic device 370 may transmit, to a server (not shown), information associated with the corresponding channel.

For example, the electronic device 370 may be a rating research device. In this case, the electronic device 370 may transmit the voice mixed signal using a channel assigned to a particular broadcasting station. The control signal 311 contained in the voice mixed signal may be transmitted using the channel assigned to the particular broadcasting station. The rating research device may receive the voice mixed signal reproduced by the reception apparatus, for example, the TV 350, the radio 360, and the like, and may identify a channel of a broadcast program received by the reception apparatus, for example, the TV 350, the radio 360, and the like. The rating research device may transmit information associated with the identified channel to a rating research server. In this case, the transmitter 330 may periodically transmit the control signal 311 to the reception apparatus, for example, the TV 350, the radio 360, and the like.

The mixing unit 320 may additionally mix the voice mixed signal with an image signal 331. The control signal 311 may include control information associated with an image at a particular time of the image signal 331.

As one example, the image signal 331 may be a concert image of a signer. In this case, the control signal 311 may include information associated with an operation of controlling a lighting device to operate at a moment when the singer takes a particular motion.

As another example, the image signal 331 may be a home shopping image with respect to a particular article. In this case, the control information may be purchase information associated with the particular article being sold on a corresponding home shopping. The electronic device 370 may access an Internet purchase site by referring to the purchase information.

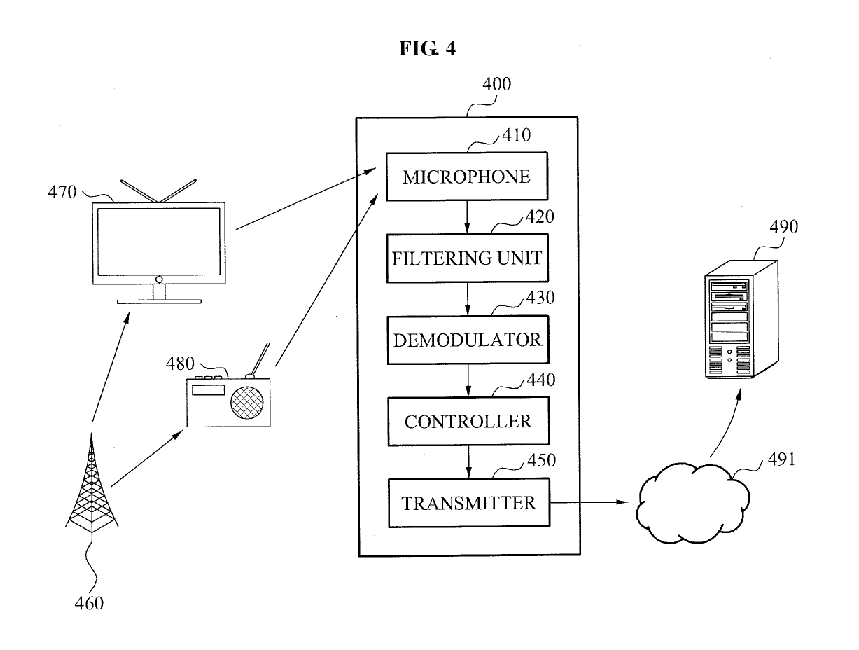

FIG. 4 is a block diagram illustrating a structure of an electronic device 400 according to an embodiment of the present invention.

Referring to FIG. 4, the electronic device 400 may include a microphone 410, a filtering unit 420, a demodulator 430, a controller 440, and a transmitter 450.

A transmission apparatus 460 may transmit a voice mixed signal to a reception apparatus, for example, a TV 470, a radio 480, and the like. The voice mixed signal may include a voice signal and a control signal.

The microphone 410 may receive the voice mixed signal reproduced by the reception apparatus, for example, the TV 470, the radio 480, and the like.

The filtering unit 420 may extract, in the voice mixed signal, a control signal modulated to an audible frequency band. The control signal modulated to the audible frequency band may be positioned in a relatively high frequency band within the voice mixed signal. A voice signal may be positioned in a relatively low frequency band within the voice mixed signal. In this case, the filtering unit 420 may extract the control signal modulated to the audible frequency band using a high pass filter.

The demodulator 430 may demodulate the control signal. For example, the demodulator 430 may demodulate the control signal using at least one modulation scheme among an FSK scheme, an ASK scheme, a QAM scheme, a PSK scheme, a CPM scheme, a TCM scheme, an OFDM scheme, and a spread spectrum scheme.

The controller 440 may perform a control operation based on the demodulated control signal.

For example, the electronic device 400 may be a rating research device. In this case, the transmission apparatus 460 may select one channel from a plurality of channels, and transmit the control signal using the selected channel. The control signal may be determined based on a channel via which the voice mixed signal is to be transmitted. The controller 440 may identify the channel via which the voice mixed signal is to be transmitted, using the control signal. The transmitter 450 may transmit information associated with the identified channel to a rating search server 490 over a network 491.

The reception apparatus, for example, the TV 470, the radio 480, and the like may reproduce a home shopping image. The reception apparatus, for example, the TV 470, the radio 480, and the like may receive and reproduce a control signal contained in a voice mixed signal associated with the home shopping image. In this case, the control signal may include purchase information associated with an article corresponding to the home shopping image. The controller 440 may access an Internet purchase page by referring to the purchase information.

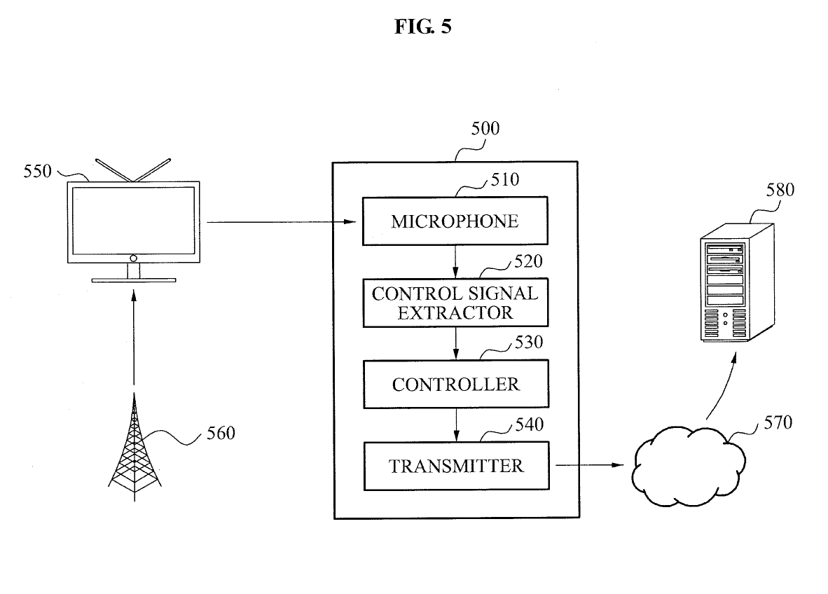

FIG. 5 is a block diagram illustrating a structure of an electronic device 500 according to another embodiment of the present invention.

Referring to FIG. 5, the electronic device 500 may include a microphone 510, a control signal extractor 520, a controller 530, and a transmitter 540.

A transmission apparatus 560 may modulate a control signal to an audible frequency band, and may mix the modulated control signal with a voice signal. A reception apparatus 550 may receive a voice mixed signal and reproduce the voice mixed signal.

The microphone 510 may receive the control signal of the audible frequency band, mixed with the voice signal. Since the control signal is positioned in the audible frequency band, a user may perceive the control signal. The control signal may be mixed with the voice signal using a masking scheme. If the voice signal and the control signal are mixed with each other only when a magnitude of the voice signal is greater than or equal to a predetermined level, the user may rarely perceive the control signal.

The control signal may be positioned in a high frequency band where human beings may have great difficulty in perceiving a sound. In this case, only women, children, and the like may minutely perceive the control signal, and other general users may rarely perceive the control signal.

The control signal extractor 520 may extract a control signal in a voiced mixed signal. The control signal may be positioned in a relatively high frequency band than the voice signal. The control signal extractor 520 may extract the control signal in the voice mixed signal using a high pass filter.

The control signal may include a device identifier, a control command, and control data. The controller 530 may compare the device identifier, included in the control signal, with a device identifier of the electronic device 500. When the device identifier included in the control signal matches the device identifier of the electronic device 500, the controller 530 may perform a control operation based on the control command by referring to the control data.

The device identifier included in the control signal may indicate an Internet accessible device. The controller 530 may compare the device identifier, included in the control signal, with the device identifier of the electronic device 500. When the electronic device 500 is accessible to the Internet, the controller 530 may determine that the device identifier included in the control signal matches the device identifier of the electronic device 500. The control data included in the control signal may be an Internet address, and the control command may be a command for accessing the Internet address corresponding to the control data. In this case, the controller 530 may access the Internet address corresponding to the control data.

As one example, the device identifier included in the control signal may indicate an information display device. The controller 530 may compare the device identifier, included in the control signal, with the device identifier of the electronic device 500. When the electronic device 500 has a function of displaying the control data, the controller 530 may determine that the device identifier included in the control signal matches the device identifier of the electronic device 500. In this case, the controller 530 may display control data that is purchase information associated with an article.

As another example, the device identifier included in the control signal may indicate a rating research device. The controller 530 may determine whether the electronic device 500 has a rating research function, and may determine that the device included in the control signal matches the device identifier of the electronic device 500 based on the decision result. In this case, the controller 530 may identify a channel via which the reception apparatus 550 receives the voice mixed signal from the transmission apparatus 560, based on the control signal. The transmitter 540 may transmit information associated with the identified channel to a rating research server 580 over a network 570.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmission apparatus, comprising:
a modulator to modulate a control signal to a frequency band within an audible frequency band;
a mixing unit to generate a voice mixed signal by mixing the modulate control signal with a voice signal; and
a transmitter to transmit the voice mixed signal to a reception apparatus,
wherein the reception apparatus reproduces the voice mixed signal, and the control signal is extracted from the reproduced voice mixed signal and is used to control an electronic device.

2. The transmission apparatus of claim 1, wherein when a magnitude of the voice signal is greater than or equal to a predetermined level, the mixing unit mixes the modulated control signal with the voice signal.

3. The transmission apparatus of claim 2, wherein when the magnitude of the voice signal is greater than or equal to the predetermined level for at least a predetermined amount of time, the mixing unit mixes the modulated control signal with the voice signal.

4. The transmission apparatus of claim 1, wherein the modulator modulates the control signal using at least one modulation scheme among a frequency shift keying (FSK) scheme, an amplitude shift keying (ASK) scheme, a quadrature amplitude modulation (QAM) scheme, a phase shift keying (PSK) scheme, a continuous phase modulation (CPM) scheme, a trellis coded modulation (TCM) scheme, an orthogonal frequency division multiplexing (OFDM) scheme, and a spread spectrum scheme.

5. The transmission apparatus of claim 1, wherein:
the control signal is determined based on a channel via which the voice mixed signal is to be transmitted, and
the electronic device identifies the channel using the control signal.

6. The transmission apparatus of claim 1, wherein:
the mixing unit additionally mixes the voice mixed signal with an image signal, and
the control signal comprises control information associated with an image at a particular time of the image signal.

7. The transmission apparatus of claim 6, wherein:
the image signal corresponds to a home shopping image with respect to a particular article, and
the control information corresponds to purchase information associated with the particular article.

8. The transmission apparatus of claim 1, wherein the transmitter periodically transmits the voice mixed signal.

9. An electronic device, comprising:
a microphone to receive a voice mixed signal reproduced by a reception apparatus;
a filtering unit to extract, in the voice mixed signal, a control signal modulated to an audible frequency band;
a demodulator to demodulate the control signal; and
a controller to perform a control operation based on the demodulated control signal,
wherein the voice mixed signal is transmitted from a transmission apparatus to the reception apparatus.

10. The electronic device of claim 9, wherein the filtering unit extracts the control signal using a high pass filter.

11. The electronic device of claim 9, wherein the demodulator demodulates the control signal using at least one modulation scheme among an FSK scheme, an ASK scheme, a QAM scheme, a PSK scheme, a CPM scheme, a TCM scheme, an OFDM scheme, and a spread spectrum scheme.

12. The electronic device of claim 9, wherein:
the reception apparatus reproduces a home shopping image associated with the voice mixed signal, and
the control signal comprises article purchase information corresponding to the home shopping image.

13. The electronic device of claim 9, wherein:
the reception apparatus receives the voice mixed signal using a channel, and
the control signal is determined based on the channel.

14. The electronic device of claim 13, further comprising:
a transmitter,
wherein the controller identifies the channel using the control signal, and
the transmitter transmits, to a server, information associated with the identified channel.

15. An electronic device, comprising:
a microphone to receive a control signal of an audible frequency band mixed with a voice signal;
a control signal extractor to extract the control signal in a voice mixed signal; and
a controller,
wherein the control signal comprises a device identifier, a control command, and control data, and
when the device identifier matches an identifier of the electronic device, the controller performs a control operation according to the control command by referring to the control data.

16. The electronic device of claim 15, wherein:
the control data corresponds to an Internet address, and
the control command corresponds to a command for accessing the Internet address.

17. The electronic device of claim 15, wherein:
the control data corresponds to purchase information associated with an article, and
the control command corresponds to a command for displaying the purchase information.
